(19) United States
(12) Patent Application Publication
(10) Pub. No.: US 2016/0031349 A1
(43) Pub. Date: Feb. 4, 2016

(54) Fastener tape for a seat pad

(71) Applicant: ILKWANG Industry Co., Ltd., Ulsan (KR)

(72) Inventors: Won Woo Lee, Ulsan (KR); Seong Ryul We, Gwangju (KR)

(21) Appl. No.: 14/562,211

(22) Filed: Dec. 5, 2014

(30) Foreign Application Priority Data
Aug. 4, 2014 (KR) 10-2014-0100008

(51) Int. Cl. B60N 2/58; A44B 18/00

(52) U.S. Cl. CPC B60N 2/5825; A44B 18/0069

(57) ABSTRACT

The present invention relates to a fastener tape for a seat pad. The fastener tape for a seat pad according to the present invention comprises: a holding sheet including a plurality of hooks formed on a top surface thereof in such a manner as to be arranged in row and column directions and spaced apart from each other at equal distances; a metal resin layer formed on an underside of the holding sheet; a polyurethane adhesive layer formed on an underside of the metal resin layer; and a shield layer joined to an underside of the polyurethane adhesive layer, wherein the shield layer comprises a base part joined to the polyurethane adhesive layer and a vertical part protruded vertically upward from both transverse sides of the base part.

### CROSS-REFERENCE TO RELATED APPLICATION

This application is based on and claims priority from Korean Patent Application No. 10-2014-0100008 filed on Aug. 4, 2014 in the Korean Intellectual Property Office, the disclosure of which is incorporated herein in its entirety by reference.

### BACKGROUND OF THE INVENTION

1. Field of the Invention

The present invention relates to a fastener tape for a seat pad, and more particularly, to a fastener tape for a seat pad, which is used to attach a seat cover to a seat pad arranged on a chair for a vehicle.

2. Background of the Related Art

In general, a seat for a vehicle (hereinafter, referred to as “vehicle seat”), which is arranged in the interior of a vehicle, consists of a foam seat pad having a cushioning force and a seat cover configured to cover the outer surface of the seat pad.

Such a vehicle seat entails problems in terms of its function in that since a seat occupant frequently sits on and leaves from the vehicle seat and further frequently moves while sitting on the vehicle seat, when the seat cover surrounding the seat pad is not securely fixed to the seat pad, it is warped according to the movement of the occupant.

In order to overcome the problem, conventionally, the seat pad and the seat cover are attached to each other by means of a fastener tape for a seat pad.

In the method of attaching the seat pad and the seat cover using the fastener tape for a seat pad, the fastener tape for a seat pad is insertingly seated in a fixing frame arranged in a mold and then an urethane resin is injected into and expanded in the mold to mold a seat pad with the fastener tape fixed thereto. However, this method involves a problem in that since the urethane resin is not smoothly bonded to a rear surface of a hook substrate of the fastener tape for a seat pad, the fastener tape is not securely fixed to the seat pad after the urethane resin is foamed to mold the seat pad.

In an attempt to solve the above-mentioned problem associated with the conventional method of attaching the seat pad and the seat cover using the fastener tape for a seat pad, there is proposed a method in which after a non-woven fabric is bonded to the rear surface of the hook substrate of the fastener tape, the fastener tape for a seat pad is insertingly seated in the fixing frame arranged in the mold and then an urethane resin is injected into and foamed in the mold to thereby manufacture a seat pad with the fastener tape fixed thereto.

This method, however, has a shortcoming in that an urethane reins permeates into the hook substrate through a gap defined between each of both sides of the inside of the fixing frame arranged in the mold and the fastener tape insertingly seated in the fixing frame during the molding of the seat pad, thereby leading to a loss of function of the hook substrate.

### SUMMARY OF THE INVENTION

Accordingly, the present invention has been made to solve the above-mentioned problems occurring in the prior art, and it is an object of the present invention to provide a fastener tape for a seat pad, in which when an urethane resin is injected into and foamed in a seat pad molding mold to mold the seat pad, the urethane resin can be prevented from permeating into a plurality of hooks through a gap defined between each of both sides of a holding sheet and a fixing frame.

To accomplish the above object, according to an embodiment of the present invention, there is provided a fastener tape for a seat pad, including: a holding sheet including a plurality of hooks formed on a top surface thereof in such a manner as to be arranged in row and column directions and spaced apart from each other at equal distances; a metal resin layer formed on an underside of the holding sheet; a polyurethane adhesive layer formed on an underside of the metal resin layer; and a shield layer joined to an underside of the polyurethane adhesive layer, wherein the shield layer comprises a base part joined to the polyurethane adhesive layer and a vertical part protruded vertically upward from both transverse sides of the base part.

According to the present invention, preferably, the vertical part may be formed to have a top surface located at a position equal to or higher than that of a top surface of each of the hooks formed on the holding sheet.

According to the present invention, preferably, an outer surface of the vertical part may be formed in an upwardly inclined shape whose width is gradually reduced as it goes toward the top from the bottom. According to the present invention, preferably, the metal resin layer 120 may be formed to a thickness of 0.35-0.5 mm, and may comprise 32.5-35 wt % of polyurethane, 59-61 wt % of iron powder, 1.5-2.0 wt % of a curing agent, and 4-4.5 wt % of toluene.

According to the present invention as constructed above, an advantageous effect is achieved in that when an urethane resin is injected into and foamed in the seat pad molding mold to mold the seat pad, it can be prevented from permeating into the hooks through a gap defined between each of both sides of the holding sheet and the fixing frame.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a fastening tape for a seat pad according to an embodiment of the present invention;

FIG. 2 is a cross-sectional view showing a fastening tape for a seat pad according to an embodiment of the present invention; and

FIG. 3 is a cross-sectional view showing a fastening tape for a seat pad, which is insertingly seated in a fixing frame arranged in a seat pad molding mold, according to an embodiment of the present invention.

### EXPLANATION ON SYMBOLS

10: molding mold
12: fixing frame
14: permanent magnet
110: holding sheet
112: a plurality of hooks
120: metal resin layer
130: polyurethane adhesive layer
140: shield layer
142: base part
144: vertical part

### DETAILED DESCRIPTION OF THE PREFERRED EMBODIMENT

Hereinafter, an explanation on a fastening tape for a seat pad according to the present invention will be in detail given with reference to the attached drawing. In the description, the thicknesses of the lines or the sizes of the components shown in the drawing may be magnified for the clarity and convenience of the description.

Further, the terms as will be discussed later are defined in consideration of the functions of the present invention, but may be varied under the intention or regulation of a user or operator or a practice. Therefore, they should be defined on the basis of the whole scope of the present invention.

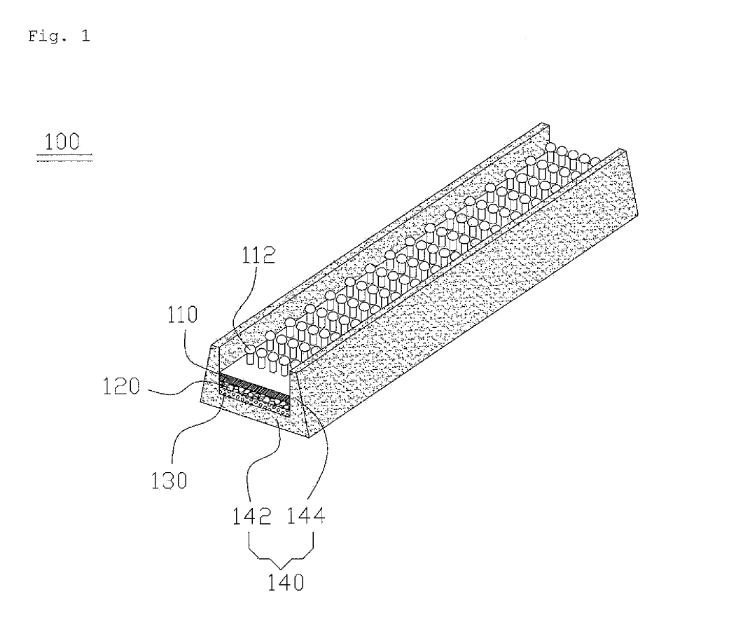

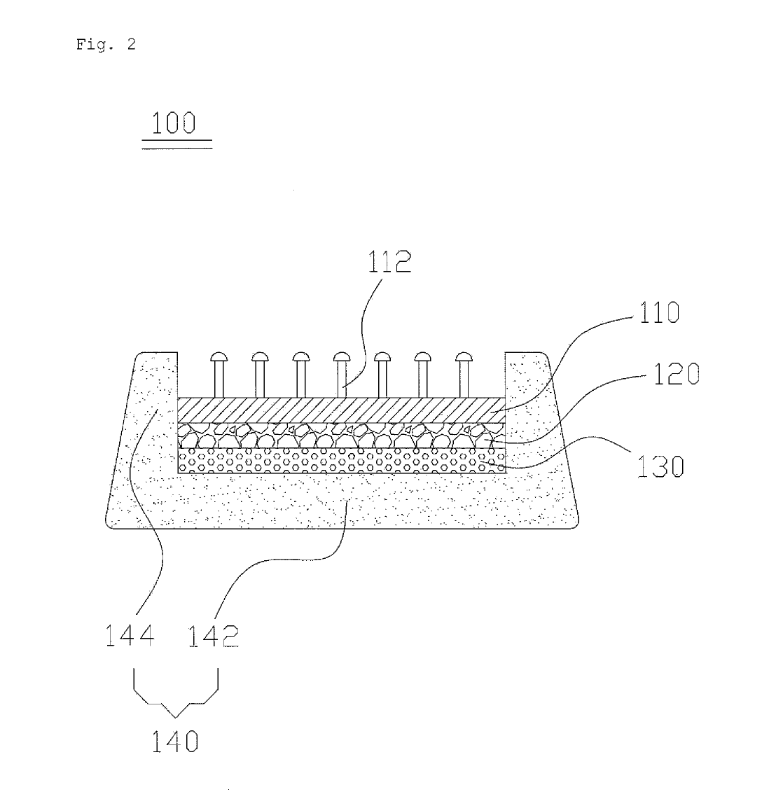

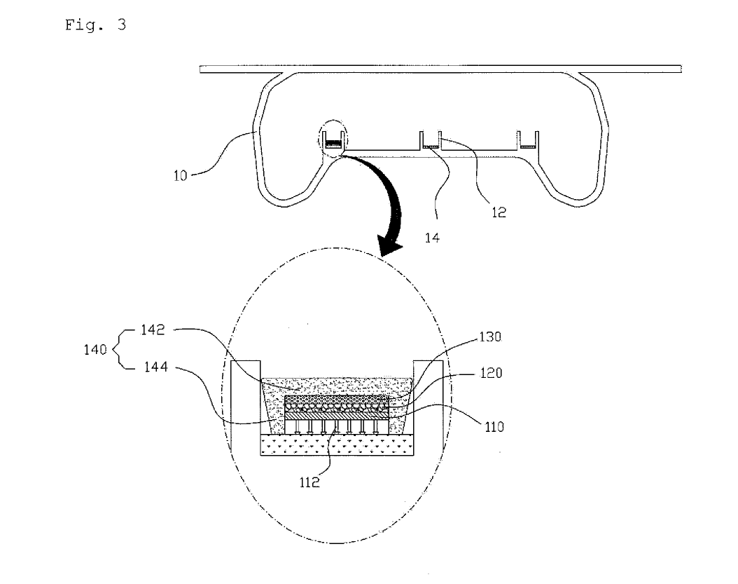

FIG. 1 is a perspective view showing a fastening tape for a seat pad according to an embodiment of the present invention, FIG. 2 is a cross-sectional view showing a fastening tape for a seat pad according to an embodiment of the present invention, and FIG. 3 is a cross-sectional view showing a fastening tape for a seat pad, which is insertingly seated in a fixing frame arranged in a seat pad molding mold, according to an embodiment of the present invention.

Referring to FIGS. 1 to 3, a fastening tape 100 for a seat pad according to an embodiment of the present invention is used to attach a seat cover to an outer surface of a seat pad 1 having a cushioning force. The fastening tape 100 for a seat pad includes a holding sheet 110, a metal resin layer 120, a polyurethane adhesive layer 130, and a shield layer 140.

The holding sheet 110 is provided with a plurality of hooks 112 formed on a top surface thereof in such a manner as to be arranged in row and column directions and spaced apart from each other at equal distances. Herein, the hook 22 may be formed in various shapes such as a hook, an anchor, and the like, if necessary.

The hooks 112 are coupled to a loop (not shown) that is attached on an inside of a seat cover (not shown), when the seat cover is covered on a seat pad (not shown).

The metal resin layer 120 is formed on an underside of the holding sheet 110 so that when the fastener tape 100 for a seat pad is insertingly seated in a fixing frame 12 arranged in a seat pad molding mold 10, it is brought into close contact with a bottom surface of the fixing frame 12 by a magnetic force of a permanent magnet 14 provided on a lower portion of the fixing frame 12, thereby preventing the fastener tape 100 for a seat pad from being separated from the fixing frame or warped during the molding of the seat pad.

The metal resin layer 120 is formed to a thickness of 0.35-0.5 mm, and comprises 32.5-35 wt % of polyurethane, 59-61 wt % of iron powder, 1.5-2.0 wt % of a curing agent, and 4-4.5 wt % of toluene.

The polyurethane adhesive layer 130 is formed on an underside of the metal resin layer 120 so that a shield layer 140 which will be described later is attached to an underside of the polyurethane adhesive layer 130.

The shield layer 140 is joined to the underside of the polyurethane adhesive layer 130 so that when an urethane resin is injected into and foamed in the seat pad molding mold 10 to mold the seat pad, it is prevented from permeating into the hooks 112 through a gap defined between each of both sides of the holding sheet 110 and the fixing frame 12.

The shield layer 140 includes a base part 142 joined to the polyurethane adhesive layer 130 and a vertical part 144 protruded vertically upward from both transverse sides of the base part 142.

In this case, an outer surface of the vertical part 144 is preferably formed in an upwardly inclined shape whose width is gradually reduced as it goes toward the top from the bottom. This is aimed at allowing the fastener tape 100 for a seat pad to be easily insertingly seated in the fixing frame 12.

In addition, the vertical part 144 is preferably formed to have a top surface located at a position equal to or higher than that of a top surface of each of the hooks 112.

Thus, the fastening tape for a seat pad according to an embodiment of the present invention has an advantageous effect in that when an urethane resin is injected into and foamed in the seat pad molding mold to mold the seat pad, it can be prevented from permeating into the hooks through a gap defined between each of both sides of the holding sheet and the fixing frame.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fastener tape for a seat pad, comprising:
a holding sheet including a plurality of hooks formed on a top surface thereof in such a manner as to be arranged in row and column directions and spaced apart from each other at equal distances;
a metal resin layer formed on an underside of the holding sheet;
a polyurethane adhesive layer formed on an underside of the metal resin layer; and
a shield layer joined to an underside of the polyurethane adhesive layer,
wherein the shield layer comprises a base part joined to the polyurethane adhesive layer and a vertical part protruded vertically upward from both transverse sides of the base part.

2. The fastener tape for a seat pad according to claim 1, wherein the vertical part is formed to have a top surface located at a position equal to or higher than that of a top surface of each of the hooks formed on the holding sheet.

3. The fastener tape for a seat pad according to claim 1, wherein an outer surface of the vertical part is formed in an upwardly inclined shape whose width is gradually reduced as it goes toward the top from the bottom.

4. The fastener tape for a seat pad according to claim 1, wherein the metal resin layer is formed to a thickness of 0.35-0.5 mm, and comprises 32.5-35 wt % of polyurethane, 59-61 wt % of iron powder, 1.5-2.0 wt % of a curing agent, and 4-4.5 wt % of toluene.
